(19) United States
(12) Patent Application Publication
(10) Pub. No.: US 2024/0430634 A1
(43) Pub. Date: Dec. 26, 2024

(54) METHOD AND SYSTEM OF BINAURAL AUDIO EMULATION

(71) Applicant: Intel Corporation, Santa Clara, CA (US)

(72) Inventors: Hector Cordourier Maruri, Guadalajara (MX); Samuel Kincaid, Santa Clara, CA (US); Willem Beltman, West Linn, OR (US); Jesus Rodrigo Ferrer Romero, Guadalajara (MX)

(73) Assignee: Intel Corporation, Santa Clara, CA (US)

(21) Appl. No.: 18/212,409

(22) Filed: Jun. 21, 2023

(51) Int. Cl. H04S 7/00; H04R 3/00; H04R 5/04

(52) U.S. Cl. CPC H04S 7/301; H04R 3/005; H04R 5/04; H04S 2400/01; H04S 2400/15

(57) ABSTRACT

A system, article, device, apparatus, and method of binaural audio emulation comprises receiving, by processor circuitry, multiple audio signals from multiple microphones and overlapping in a same time and associated with a same at least one audio source. The method also comprises generating binaural audio signals comprising inputting at least one version of the multiple audio signals into a neural network.

### BACKGROUND

Spatial or 3D audio or immersive sound rendering permits a person to hear sound as if the person listening to the audio was in a 3D position among the audio sources. For example, if the audio imitated a symphony orchestra, and the audio was based on the microphones being in the middle of the orchestra, a person listening to such audio on headphones could hear violins in front of them while hearing trumpets in back of them, and so forth. Similarly in a video conference, a person speaking on the left of a conference microphone will sound as if the person speaking is located to the left of the person listening to the audio and viewing the video conference. Such systems take advantage of the binaural nature of the ears where the distance from a source is slightly different from ear to ear and the physical features of the human head itself causes differences in the characteristics (frequency, volume levels, etc.) of the audio signals generated by the ears. Thus, a human brain can determine source location (referred to as localization) due to the differences in the audio signals from the two ears. The use of binaural audio permits more efficient or more entertaining remote collaboration, content creation and consumption, virtual or augmented reality, and gaming that provides excellent realism. Current binaural audio applications, however, are very limited because the locations of the audio sources relative to the microphones being used to record audio often must be known beforehand and only certain types of binaural microphones can record the audio, which is not available on common consumer products.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an audio processing system with a microphone array providing binaural audio emulation according to at least one of the implementations disclosed herein;

FIG. 2 is a flow chart of an example method of audio processing for binaural audio emulation according to at least one of the implementations disclosed herein;

FIG. 3 is a schematic diagram of an audio binaural emulation neural network according to at least one of the implementations disclosed herein;

FIG. 4 is a flow chart of an example method of training a neural network for a method of binaural audio emulation according to at least one of the implementations disclosed herein;

FIG. 5 is a schematic diagram of an audio processing system for training a neural network of a binaural audio emulation device according to at least one of the implementations disclosed herein;

FIG. 6 is an image of an audio recording environment used for the training method of FIG. 4 and training system of FIG. 5;

FIG. 7 is a schematic diagram of an audio source position map for the training method of FIG. 4;

FIG. 7A is a coordinate axis diagram for orientation of directions on FIG. 7;

FIGS. 8A-8C are images of spectrograms of the input, binaural output, and binaural target audio signals obtained while training and testing an audio binaural emulation neural network according to at least one of the implementations disclosed herein;

FIGS. 9A-9C are images of audio signals respectively corresponding to the spectrograms of FIGS. 8A-8C of the input, binaural output, and binaural target audio data obtained while training an audio binaural emulation neural network according to at least one of the implementations disclosed herein;

FIG. 10 is an illustrative diagram of an example system;

FIG. 11 is an illustrative diagram of another example system; and

FIG. 12 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless the context mentions specific structure. For instance, various architectures employing, for example, multiple integrated circuit (IC) chips and/or packages, and/or various computing devices and/or consumer electronic (CE) devices such as laptop, desktop, or other personal (PC) computers, tablets, mobile devices such as smart phones, smart speakers, or smart microphones, conference table microphone(s), video game panels or consoles, high definition audio systems, surround sound or neural surround home theatres, television set top boxes, and so forth as long as such devices can provide binaural audio signals to, or is, a binaural output device such as headphones, headsets, hearing aids, or other binaural devices, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

As used in the description and the claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

### Systems, Articles, and Methods of Binaural Audio Emulation.

Recording audio to output binaural audio at an end or output audio device often requires very expensive and delicate equipment including the use of binaural heads or head and torso simulator (HATS) that has a mannequin head with microphones at the inner ear positions, or binaural head-worn microphone headsets with microphones near the ear positions. These devices are usually only available in acoustic laboratories and commercial manufacturing settings. The devices are bulky and are not practical to integrate into consumer devices since the devices replicate the shape and size of a human head and are therefore not compatible with the microphone arrays that are integrated into typical consumer devices.

Another conventional method of binaural emulation uses digital models such as head related transfer functions (HRTFs) with angle of arrival detection. The HRTF system synthesizes audio coming from multiple sources, where the audio stream for each source is convolved separately and by using an HRTF corresponding to the source's location relative to a listener's cars. A set of known audio signals or streams from multiple known audio sources with known positions then can be superimposed to construct a complete multi-source signal. As a result, such HRTF systems also are impractical for binaural rendering for mobile devices or PC computers for example.

For a single source, an angle of arrival (AoA) type algorithm can be used to determine the source orientation, and beamforming can be used to enhance the recorded signal from an on-board microphone array. This approach, however, does not scale. Specifically, when multiple audio sources exist in an acoustic environment, the audio system built for a single audio source can extract the audio streams and determine locations of the multiple audio sources, but this often results in audible artefacts even in the case of just two audio sources. Such HRTF systems and similar modeling techniques are therefore usually constrained to generate one-audio source at a time and are usually created for anechoic (reverberation-free) environments. Also, realistic environments with multiple audio sources often require additional room modeling and sound rendering. Using these systems to re-create binaural audio from a real (non-lab) location during a run-time would require extensive image recognition, environment scanning, and HRTF sound rendering, resulting in a very computer intensive pipeline. Thus, no scalable, well performing solution exists for generating binaural signals from the existing microphone arrays on consumer devices.

To resolve these issues, the method and system described herein may generate immersive binaural audio signals from non-binaural audio signals captured on any of a variety of audio recording or input computing devices including small mobile devices or personal computers that have multiple microphones, such as a linear or circular microphone array, or microphones in any other microphone pattern as long as the multiple microphones have a sensitivity that is directional. The disclosed system performs an audio signal conversion using a machine learning algorithm, and specifically by at least one binaural audio emulation neural network (NN). The NN receives multiple audio signals as input, and outputs two emulated 3D or binaural (e.g., right and left) audio signals that would be expected by human ears to indicate the distance and/or direction of an audio source.

The NN is trained with real audio signals generated by simultaneously capturing emitted audio with both non-binaural sets of microphones, such as a microphone array, and a binaural recording device with two microphones at ear locations of a headset or mannequin head. The binaural audio signals are used as the ground truth NN target or expected audio signals for supervised training, while the non-binaural audio signals of the set of multiple microphones are input to the NN to generate NN output or estimated audio signals. The target and output audio signals are then compared in a loss function to determine when the NN is ready for run-time use. The audio sources may be arbitrary source inputs, such as speech, music, or other audio events. After the network is trained, and during an inference or run-time, the system then can produce binaural-emulated 3D sound based on non-binaural multiple microphone inputs.

With this binaural audio emulation system and method, the binaural audio emulation NN may accurately capture, or inherently generate, the interaural time and level differences that are important to human perception, localization, and/or immersion. This disclosed NN arrangement is scalable in number of audio sources and number of input microphones, and performs well for multiple overlapping audio sources.

The present system and method also can work with a simple inexpensive microphone array, and a processing unit capable of inferences with the disclosed NN or model. Existing microphone arrays on many different devices, such as on notebooks or laptops, can be used both to train the NN and to generate binaural audio signals during a run-time. Thus, the solution herein allows for obtaining 3D binaural audio signals with very inexpensive equipment that is already integrated into platforms.

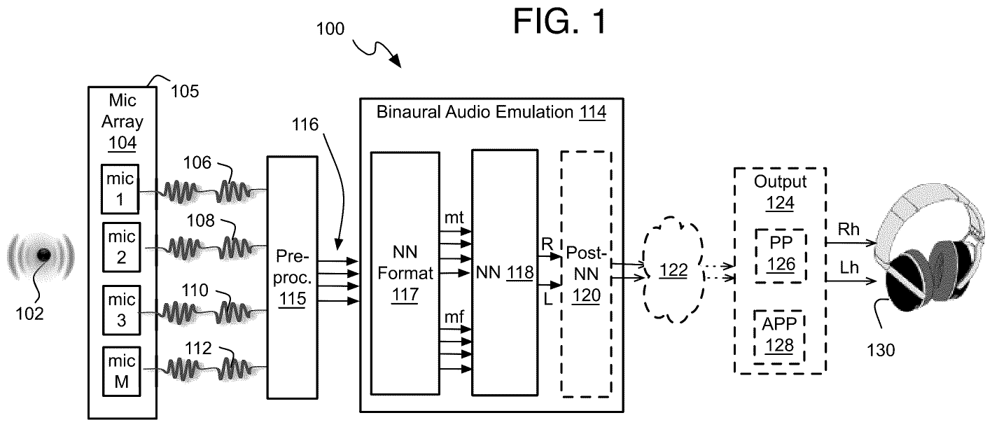

Referring to FIG. 1, an example audio processing system 100 has an audio source (or pick-up) device or input device 105 with a microphone array 104 that has a set of multiple microphones 1 to M and that receives acoustic waves from at least one audio source 102. By one example, four microphones are being used. The number and type of audio sources 102 is not particularly limited and may be one or more people speaking, music, or any other one or more audio events or sounds. A person speaking or other sound source 102 may emit acoustic waves into the air within a pickup range of the microphone array 104.

The microphone array (or mic array) 104 may be any microphone array with at least two microphones, and may be any type of microphones on any type of source device, listening device, or input device 105 as long as the shape of the array and number of microphones provide a sensitivity with directionality (e.g., not omnidirectional). This may include a linear array, circular array, grid array, or any other array shape (also referred to as a microphone pattern or just pattern). The microphones 1 to 4 (106, 108, 110, and 112) each may generate a non-binaural initial audio signal that will eventually be input to a binaural audio emulation unit 114 that has a binaural audio emulation neural network or neural network arrangement (or just NN) 118. The pattern of the microphone array 104 should correspond to the pattern used during training of NN 118, and the number of microphones can be other than four, but should be the same or more than the number of microphones used for training the NN 118. When the microphone array has more than the number of microphones used for training, then microphones above the number of training microphones may be disabled. The run-time microphone array also should have the same distances between microphones and same relative positions among the microphones with the same sampling frequencies compared to a training array in order to achieve the performance levels achieved during training.

By some examples, the input device 105 to be used during a run time to capture audio signals may be any computing device with live microphones such as mobile devices such as a laptop, notebook, tablet, smartphone, or any smart device. Otherwise, input device 105 may be a desktop computer, extension monitor with mics, or other computing device with microphones. In some forms, the binaural audio emulation unit 114 is on the same device as the microphones mentioned above. In other examples, the binaural audio emulation unit 114 is on one or more of the devices mentioned above while the device 105 with microphones is a separate listening or input device that provides audio signals, such as peripheral devices with microphone arrays, such as headset microphone wand with multiple microphone arrays, studio and/or stand-alone (or free-standing) microphone arrays to name a few examples, and as long as such microphone arrays are wirelessly or wired to a device with the binaural audio emulation unit 114 to provide audio signals from the microphone array 104 to the binaural audio emulation unit 114. By another example, the binaural emulation unit 114 may be on a remote server or other computing device. Thus, the type and number of microphones is not otherwise limited other than as mentioned above and as long as the microphones can convert acoustic waves into a raw audio signal and can be networked to provide the audio signals to the binaural audio emulation unit 114.

It also will be appreciated that while the example herein describes a microphone array or pattern 104 on a single device 105, the system 100 may work with single microphones on multiple separate devices forming a microphone array or pattern, such as an array of studio or free-standing microphones, or multiple devices or mix of devices described above. In this case, the device should be static and the captured signals are synchronized.

The separate initial audio signals 106, 108, 110, 112 either may be provided as raw audio signals with no pre-processing or may be modified by pre-processing. By one form, the audio signals may be constructed by using a sampling rate with or without a hop, such as 48 KHZ with a 50% hop, as one example. The pre-processing, may be performed by a pre-processing unit 115, the microphone array 104, microphones 1 to 4 individually, and/or the listening device 105 itself. This may include performing pre-processing such as analog-to-digital (ADC) conversion, acoustic echo cancellation (AEC), denoising, dereverberation, amplification, automatic gain control (AGC), beamforming, dynamic range compression, and/or equalization to provide a cleaner, more desirable audio signal. Some of these techniques, such as ADC, should be performed to obtain audio signals in an expected condition for binaural audio emulation. In some cases, however, such initial denoising and other microphone or device specific pre-processing could provide unexpected audio signal data to the binaural audio emulation neural network that results in inaccurate emulation or unwanted distortion. In these cases, the mic will not be used when no way exists to automatically or manually disable the extra pre-processing. It will be understood that such an option to automatically or manually disable pre-processing techniques may be available.

Also, it should be mentioned that when the microphone array 104 is on a single device, the microphones 1 to M are most likely being synchronized to the same clock circuitry so that the audio signals form the microphone array 104 are already synchronized with each other. By other options, and when the microphones have different clocks, whether on the same device or different devices, then in this case the pre-processing unit 115 also may perform synchronizing of the audio signals to align them to each other and with a maximum allowable difference in time determined by experimentation.

The pre-processing also may include any compression and decompression when the audio signals 106, 108, 110, 112 are to be transmitted through wires and/or wirelessly to the binaural audio emulation unit 114, and whether through internal circuitry, or personal, local area, or wide area networks, to the binaural audio emulation unit 114.

The now pre-processed audio signals 116 then may be provided to binaural audio emulation unit 114, and by one particular example, by being placed in one or more NN buffers. A NN format unit 117 then may modify the audio signals 116 to construct the audio signal inputs to be input into the NN 118. This may include collecting the audio signal samples into frames (or blocks of data) expected by the NN 118. For one example, say about 200,000 samples may be collected to form a single frame of about four seconds. For the time domain, a 1D time domain vector for each frame is generated to be input into the NN 118 where each vector has a number of samples (or amplitudes or magnitudes) along the duration of a single frame (which may be 4-4.5 seconds, or up to 4.5 seconds, such as 170 milliseconds or about 150-200 milliseconds in one other example). Multiple channels are provided with one channel for each microphone. The time domain input vector of the same single frame time (time point, time stamp, or time period) may be input channel by channel into the NN 118 as shown by time domain channels (or 1D vectors) mt, here being four channels for four microphones in the continuing example. In a continuous streaming manner (i.e., consecutively), the sets of 1D vectors of channels of a same frame time also then may be input frame time after frame time into the NN 118 in a continuous, consecutive manner, although intervals could be used when desired. More detailed examples are described below.

The NN format unit 117 also then may generate frequency domain frames (or blocks of data) by applying feature extraction, such as short-time Fourier transform (STFT), to generate frequency domain (or spectrum) values of frequency bins for each frequency frame. By one form, the number of frequency bins may be set equal to a reduction factor, and the input number of frequency encoder output spectrum values per frequency bin equals the number of values output from the time domain encoder for each channel. Thus, the dimensions at the outputs of the encoders are the same due to the frequency domain compression of the frequency data through the frequency bins dimension, and the time domain compression of the time domain data through the audio signals' length/duration dimension.

Particularly, the reduction factor indicates how many times the time domain encoder will reduce the audio signals' length, and in turn how many encoder blocks are being used, by the time propagated audio signal data is output by the time domain encoder. By one example, a reduction factor of 256 is used for a time domain frame length of 8192 samples. This frame length produces an encoded length of 32 values, so that the frequency input frame also should have 256 frequency bins and 32 spectrum values for each bin. Due to the symmetrical nature of STFT windows, the symmetry causes half of the produced data from the STFT to be useless. So if 256 useful frequency bins are desired, then a window length double that of the desired number of bins should be used, and the second half of the data is dropped. Also, once the STFT window length is set, then a hop can be computed that will return the same number of spectrum values as the time domain encoded length, where:

(timeDomainFrameLength−(STFTWindowLength/2))/timeDomainEncodedLength=hop steps (A)

which in this example may be: (8192−(512/2))/32=248 steps. The hop is then 248/512=0.4844 (approx. 48% hop or about 50%). Thus, by setting the STFT with a window length of double the reduction factor (2*256=512) and factoring the symmetry effect of the STFT, a hop of 248 steps (or approximately 48% or 50%) may be used.

An input frequency 2D surface then is frequency bins versus spectrum samples or values for each bin. The reduction factor can be computed depending on the stride and number of layers (or encoder blocks) being used. As a result, the number of channels and the encoded length (encodedLength) of encoded values per channel at the output of the frequency domain and time domain encoders will be the same. Other details are provided below. In the present example, the symmetry can be used because no frequency scaling is performed no matter the type of audio source. Alternatively, however, it will be understood that feature extraction for a Mel-frequency spectrum or Bark scale may be used when human speech is expected and to be emphasized in the audio. The frequency domain frames of the different available microphones are then combined into a 2D input array or surface of frequency bins x frequency spectrum for each frequency bin and for each microphone where multiple channels mf each form an individual 2D frequency domain surface of a same frame time. Thus, the frame construction may be performed while preserving the 1D time domain vectors or frames so that both domains can be used as described below. It also will be understood that this is one example of the input format for the NN 118 and other formats may be used instead.

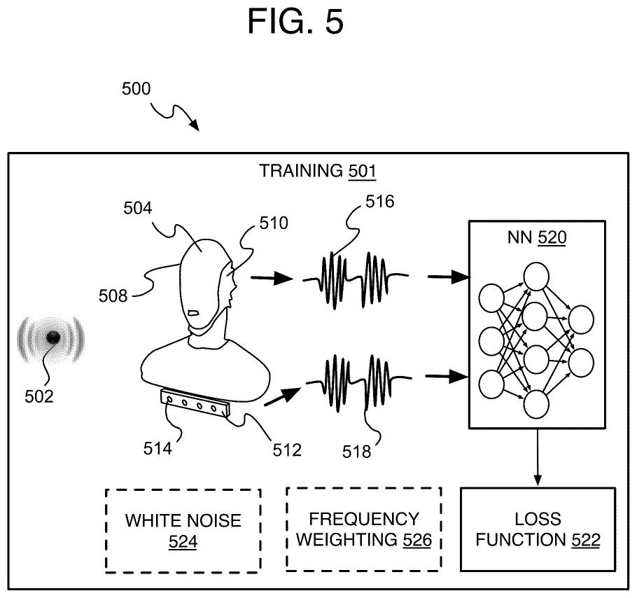

The time domain input 1D vector and the frequency domain 2D input surface then may be input into the NN 118, and with one 2D frequency surface representing a single frame of frequency bins x spectrum values, while the input of the 1D time domain vector represents a single frame time as well so that both time domain and frequency domain frames are being input to the NN 118 and are associated with multiple channels of the same frame time. By one example, form the NN 118 may have a frequency encoder that receives multi-microphone frequency domain input, a time domain encoder that receives multi-microphone time domain input, and a decoder that outputs binaural audio signals. The time domain encoder and time domain decoder form a U-net type of neural network in this example. The output of each encoder may be combined at a bottleneck of the U-net time domain encoder-decoder to form input for the decoder. By one example form, the encoders and decoder may include encoder blocks with a combination of convolutional, rectified linear unit (ReLU), and gated linear unit (GLU) layers. The encoders and decoder may be considered portions of a single NN 118, or NN 118 may be a NN arrangement where each encoder and decoder is considered a separate NN. While not shown, one or more parts, or all, of a training unit (FIG. 5) for training the NN 118 may or may not be part of, or may accompany, the binaural audio emulation unit 114.

Hardware used to operate the NN 118 may include accelerator hardware such as one or more specific function accelerators with one or more multiply-accumulate circuits (MACs) to receive the NN input and additional processing circuitry for other NN operations. By one form, either the accelerator is shared in a context-switching manner, or one or more accelerators may have parallel hardware to perform binaural audio emulation conversion to different sections of a frame, different frame time periods, or other processing partitions in parallel. By one form, the NN 118 then outputs right R and left L binaural audio signals, and that may be stored in an output buffer (not shown). Other details of the NN 118 are provided below.

The system 100 may provide the output binaural audio signal for further audio processing in the form of frames that are the same length (or duration) as that provided at the input of the time domain encoder. Otherwise, the system 100 also may have a post-NN unit 120 to reconstruct the frames of the binaural audio signals into continuous binaural audio signals, such as by applying an overlap-and-add type of process to remove the overlap (or hop). Optionally, the post-NN unit 120 also may perform any post-processing on the binaural audio signals when desired. In one example, normalization or automatic gain adjustment may be applied when the NN undesirably causes jumps in gain.

Thereafter, when the binaural audio signals are to be transmitted to remote output devices, such transmission may be through a communications or computer network 122. Network 122 may be a wide area network (WAN), local area network (LAN), or even a personal area network (PAN). The network 122 may be, or include, the internet, and may be a wired network, wireless network, or a combination of both. By one example form, network 122 is a device-to-device (D2D) direct interconnect network.

The binaural audio signals then may be received by an output device 124 shown here and that can be a laptop, desktop, tablet, or other computer, server, or other output device that is communicatively coupled to, or paired to, a headset or headphone 130. By an alternative, the headphone 130 is the output device 124. The output device 124 may have its own end-use or end-application (or stream) pre-processing (PP) unit 126, and may perform pre-processing needed for transmission and/or emission or broadcast, or for specific end applications. This may include denoising and other techniques mentioned below.

The headphones 130 may be any type of headphone or binaural audio output device as long as separate binaural audio signals Rh and Lh can be received by separate speakers, each speaker for one ear. The result is realistic 3D binaural audio at the headphones 130, even though the audio was first recorded at non-binaural audio arrays, such as a linear or circular array for example.

Otherwise, the output device 124 may have an audio application 128 to perform audio processing, and by using the binaural audio signals. Thus, whether or not compressed and transmitted to a remote device, the selected audio signal may be provided for automatic speech recognition (ASR), speaker recognition (SR) angle of arrival (AoA) detection, beam forming, and so forth.

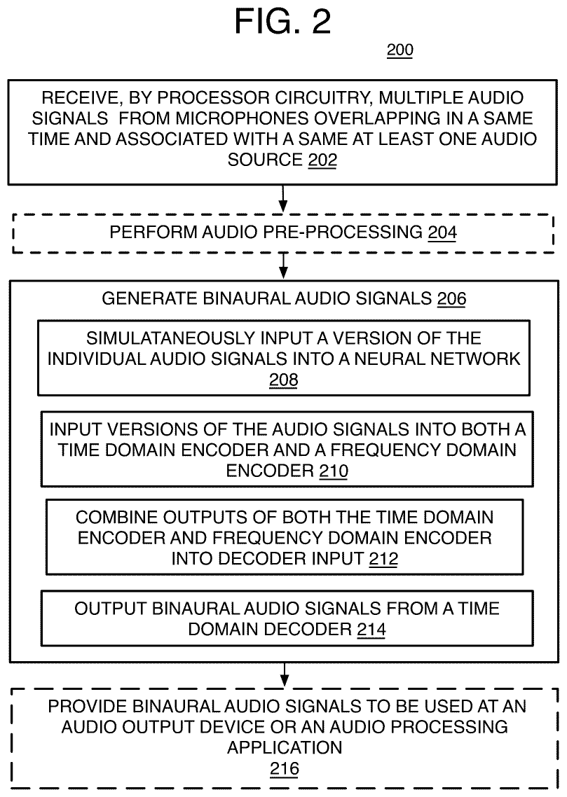

Referring to FIG. 2, an example process 200 for audio processing and particularly for binaural audio emulation is provided. In the illustrated implementation, process 200 may include one or more operations, functions, or actions as illustrated by one or more of operations 202 to 216 generally numbered evenly. By way of non-limiting example, process 200 may be described herein with reference to example systems 100, 500, 1000, 1100 and 1200, and neural network 300 described herein with FIGS. 1, 3, 5 and 10-12, or any of the other systems, devices, processes, environments, or networks described herein, and where relevant.

Process 200 may include “receive, by processor circuitry, multiple audio signals from multiple microphones and overlapping in a same time and associated with a same at least one audio source” 202. This may include many different types of audio environments with many different types of audio input or source (or listening) devices as long as the input device has at least two microphones or microphone array with a pattern shape and directional sensitivity as described above. The binaural audio signal emulation process works without the need of expensive binaural audio capture equipment during a run-time or real time.

This operation 202 also may include receiving audio signals associated with audio emitted from multiple audio sources at the same time. Same time here may refer to a single time point or a time period, and may be determined by a time stamp of a sample or frame of the captured audio signals for example. It also should not matter how many audio sources are present, although at some point the more sources, the more the determined directions of the sources may become less accurate, such as when more audio sources are being used than the number of microphones.

The device receiving the audio signals to perform binaural audio emulation may be the same device with the microphones or may be a different device remotely coupled to the device with the microphones as described above with system 100. Any computing device with sufficient capacity may be used to operate the binaural audio emulation unit as long as a user can use the device during a run-time and live (or real time), whether during a video or phone conference, or other audio event so that such binaural audio recordings can be generated at home, while travelling, in videoconferences, and so forth.

This operation 202 also may include capturing samples at a sample capture rate that is expected by the binaural audio emulation unit or neural network. By one example, the sampling rate is 48 kHz with a 50% overlap or hop, although other sampling rates can be used instead.

Process 200 optionally may include “perform audio pre-processing” 204, and this may include any of the pre-processing techniques described above with pre-processing unit 115 and when desired to begin preparing the audio signals to be modified for the neural network. The pre-processing may include denoising, and so forth, as listed above, and may include synchronization between signals from different microphones when it has not already been performed.

Process 200 may include “generate binaural audio signals” 206, and specifically by having a neural network emulate binaural audio signals during a run-time (or live or in real-time). This operation 206 may include “simultaneously input a version of the individual audio signals into a neural network” 208, and specifically to “input versions of the audio signals into both a time domain encoder and a frequency domain encoder” 210. Thus, by one example form, the multiple audio signals may be converted into time domain frames, and the time domain frames then may be converted into frequency domain frames. The frequency domain frames may be collected into a 2D frequency surface for each microphone (channel) that then may be input to a frequency domain encoder of the example neural network, while time domain vectors may be generated and input one by one for each channel of the same frame time into a time domain encoder of the example neural network. Thereafter, operation 206 includes “combine outputs of both the time domain encoder and frequency domain encoder into domain decoder input” 212. By one form, the encoder outputs are summed element by element before being input to the decoder, although other combination computations could be used instead. As to architecture of the NN, one or more of the encoders and decoder of the neural network may have a sequence of encoder or decoder blocks with a similar layer structure. By one example detailed below, one or more of the encoder blocks use two convolution layers, a gated linear unit (GLU) layer, and a rectified linear unit (ReLU) layer, while one or more of the decoder blocks use one direct convolutional layer and a transpose convolutional layer instead of the two convolutional layers.

The operation 206 then provides “output binaural audio signals from a time domain decoder” 214. Thus, the decoder outputs time domain binaural audio signal frames, and by one form, with the same duration as the input time domain frames. The output binaural audio signals can be reconstructed into continuous binaural audio signals for further audio processing and emission.

Process 200 then may include “provide binaural audio signals to be used at an audio output device or audio processing application” 216. Here, the binaural audio signals may be compressed, transmitted over a computer or communications network to a remote output device, and decompressed. Whether or not transmitted, the binaural audio signals then may be emitted at headphones, headsets, or other two-speaker devices that can emit binaural audio, and/or used for further processing such as ASR. SR, and so forth.

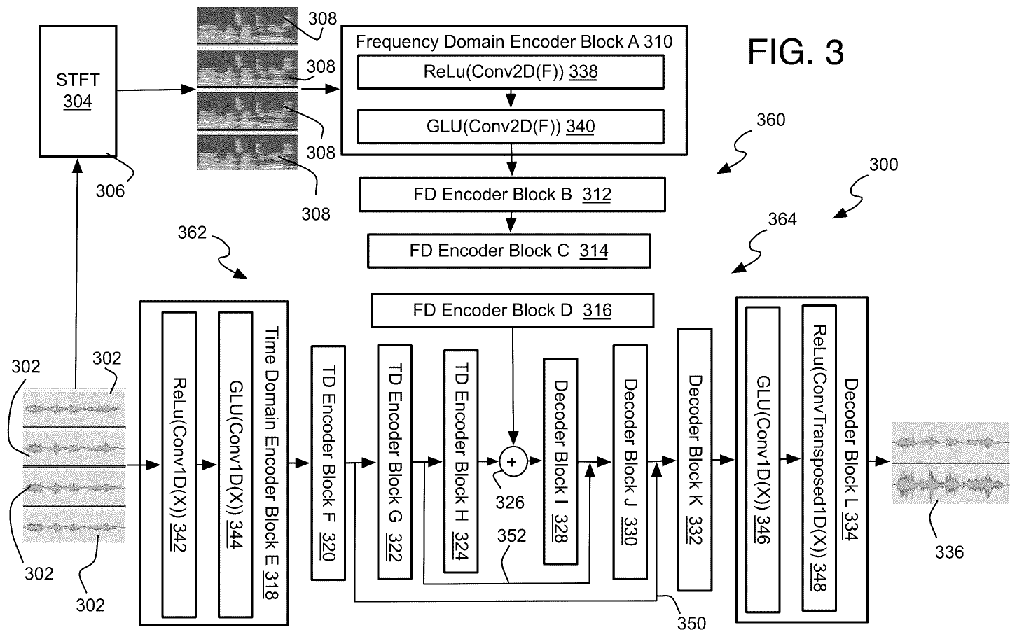

Referring to FIG. 3, an example binaural audio emulation neural network 300 has architecture with a convolutional 2D encoder for the frequency domain, and a 1D time domain U-net type encoder-decoder with skip connections between same level blocks for the time domain. Frequency encoded data output from the frequency domain encoder may be fed into a bottleneck of the time domain U-Net type structure. With this example structure, the example NN 300 has two encoders and a single decoder.

Specifically, a NN format unit 306 may divide the audio signal samples into time domain frames and may provide the time domain frames to an STFT unit 304. The time domain frames each may be provided as a 1D vector and for each microphone to form a separate input channel 302. Each vector of a same channel (same microphone) is a frame of a different time (different start time, time period, or time stamp for example) so that the 1D vector can be input into the NN 300 as a sequence of consecutive frames (although other intervals could be used) and as representing a continuous audio signal. The elements of the time domain 1D vectors of each channel 302 are each a different audio signal magnitude (or amplitude) along the duration of the single frame. By one form, the time domain frames are each 4 to 4.5 seconds in duration, or up to 4-5 seconds, and by one example, includes 204,800 samples at 48 kHz for 4.26 second frames, or by other examples, includes 8,192 samples at 48 kHz for frames with a duration of 170 milliseconds (or 0.171 milliseconds by one form), or about 150-200 milliseconds. Since each 1D vector is provided for a single microphone, multiple channels 302 (here being four channels for four microphones) are used so that each microphone has its own NN input channel. Thus, each channel 302 is or has a 1D vector or frame, each with the 204,800 (or 32,768 or 8,192 by other examples) samples and a 50% overlap from frame to frame in this example. In this example, the 1D time domain vectors also may be grouped in a batchsize, such as for training, for a batch of 32 frames for example providing an example input size of (batchsize, channels, samples), and by one example (32, 4, 8,192) forming an input time domain tensor, although input into the NN 300 a 1D vector at a time as described above. Alternatively, it will be understood that the time domain input could be input as a 2D surface with multiple frames when multiple networks, sufficient RAM, sufficient vRAM on a GPU, and/or other circuitry are provided for parallel processing for example. Many variations exist.

The frequency domain also may be described as input frequency domain tensors where the batch size (batchSize), used particularly during training, and is equal to the number of frames to be processed during a certain duration of multiple frames. By one example, the batch size may be 1 for online or real time processing, and may be 64 for offline processing. The frequency domain, however, also may be described with frequency bins as a fourth dimension where the frequency input dimensions are (batchSize (when training), channels, frequency, length), which by one example may be (32, 4, 256, 64). The length is frequency or spectrum values provided for each frequency bin, which does not need to be the same length as in the time domain. With this structure, a 2D surface being input to the frequency domain encoder at a single time represents frequency bins (here 256)×spectrum values (here being 64), and this is repeated for each channel, and then for each frame.

The STFT unit 304 may provide frames of the same time duration, but different length in number of elements, as the time domain frames (here 4.26 seconds or 170 milliseconds depending on the example) due to the symmetry explained above. The STFT also provides a number of frequency bins equal to a length reduction factor of the time encoding layers, and with a length equal to the encoded length of the time domain frame. Specifically, the reduction factor indicates the change in the number of sample values or elements from the input to the output at the time domain encoder. By one of the present examples, the encoder may start with 8,192 samples per channel in a vector and outputs 32 samples per channel. The reduction factor indicates a reduction factor of (8192/32=256). The reduction factor also can be determined depending on the number of encoder blocks (or layers) and stride. This reduction factor is computed as the stride value to a power equal to the number of blocks, For example, if stride=4, encoder blocks=4, then the reduction factor=256, ex. Stride=4, layers=4, so 4\hat{ }4=256. This may be 512, 1024, or 2048 in other examples depending on number of samples, desired encoded length, and so forth. The result is frequency 2D input surfaces or channels 308 for each microphone, and where four channels 308 are provided for four microphones in this example and provided frame time by frame time according to the batchsize if being used. The frequency values may be converted into a dB scale for input to the NN.

One example neural network architecture that may be used may include a frequency domain encoder or encoder portion 360, a time domain encoder or encoder portion 362, and a decoder or decoder portion 364. The decoder may be considered a time domain decoder since binaural output 336 from the decoder 364 is in the time domain.

By one approach, the encoders 360 and 362 each may include a sequence of similar encoder blocks, such as time domain encoder blocks E 318, F 320, G 322, and H 324 in the time domain encoder 362, and frequency domain encoder blocks A 310, B 312, C 314, and D 316 in frequency domain encoder 360. The first encoder blocks 310 and 318 respectively of the two encoders 360 and 362 show the similar layers of individual or all of the encoder blocks. A chart of the encoder block structure with layers 338 and 340 in the frequency domain encoder blocks and layers 342 and 344 in the time domain encoder blocks. (F) refers to frequency and (X) refers to time domain. The encoder block is shown below on Table 1.

TABLE 1

| Layer | Time and Frequency Domain Encoder Blocks: |
|---|---|
| Convolutional 1 | For each in channel = 1, Out channels = 2, kernel |
| | size = 8, and stride = 4 |
| ReLU | ReLU activation |
| Convolutional 2 | For each in channel (same as conv 1 out) = 2, |
| | Out channels (2* conv 1 out) = 4, kernel size = 1, |
| | stride = 1 |
| GLU | GLU activation |

The following Table 2 shows the changes in the number of channels at each encoder block. It should be noted that the first encoder blocks at each encoder 360 and 362 receives as input the frames of each microphone one after another and for the same frame time. With the present example herein, four frames or 1D vectors are received for a single frame time. Therefore, based on the example herein, four input vectors will be received for four microphones as four channels. The number of output channels for the first encoder block may be an adjustable parameter to obtain desired output dimensions at the encoder outputs (before being combined and input to the decoder. By one form, the first encoder blocks 360 and 362 output 32 channels when four channels are input, and thereafter, the subsequent encoder blocks output double the number of channels inputted to the encoder block as one example.

TABLE 2

| Encoder Block | Encoder Block Channel Specification |
|---|---|
| A and E | Channels in = 4 (number of mics), Channels out = 32 |
| B and F | Channels in = 32, Channels out = 64 |
| C and G | Channels in = 64, Channels out = 128 |
| D and H | Channels in = 128, Channels out = 256 |

Thus, by one example form, the encoded shape at the output of the frequency decoder is frame length=64 (or 32), batchSize=32, and encoded shape such as (32, 256, 1, 64). Since 1 frequency bin is provided to form a vector, time and frequency domains now have the same encoder output shape (vectors for example) and can be combined.

By the example herein, the output of both example encoders is 256 channels each with a vector of encodedLength intermediate (or convolved) elements or values, where the encoded length may or may not be the same for both the frequency and time domain encoder outputs. By one example architecture, the encodedLength is the same and an adder 326 may perform element-wise addition (for example, frequency domain element #1+time domain element #1, and so forth) to generate 256 channels of encodedLength vectors as input for the decoder 364. It will be understood that other computations may be used to combine the encoder outputs instead, such as element-wise multiplication, tensors concatenation, etc.

The decoder 364 may include a sequence of similar decoder blocks I 328, J 330, K 332, and L 334. Each decoder block may have layers 346 and 348, and as recited below in Table 3. Channel number conversions are as shown in Table 4. The tables 3 and 4 show how the number of input and output channels of each block are generally a reflection to those shown on Tables 1 and 2. In order to preserve the same shape on each equivalent level between the time domain encoder and decoder, the NN 300 may apply skip connections 350 and 352. The last decoder output layer outputs 2 channels with the rendered binaural audio.

Thus, as with Tables 1-2 except in the reverse order, the first three decoder blocks I-K may halve the number of channels, while the last decoder block has an input number of channels that may be an adjustable parameter to obtain desired output dimensions at the decoder, here being two output emulated binaural audio signals 336. By one form, the input to the last decoder block 334 is 128 channels.

TABLE 3

| Layer | Time Domain Decoder Blocks: |
|---|---|
| Convolutional 1 | For each in channel = 2, Out channels = 4, kernel |
| | size = 1, and stride = 1 |
| GLU | GLU activation |
| Transpose | In channel = 2, Out channel = 1, kernel size = 8, |
| Convolutional 2 | stride = 4 |
| ReLU | ReLU activation |

TABLE 4

| Decoder Block | Decoder Block Channel Specification |
|---|---|
| I | Channels in = 256, Channels out = 128 |
| J | Channels in = 128, Channels out = 64 |
| K | Channels in = 64, Channels out = 32 |
| L | Channels in = 32, Channels out = 2 (binaural) |

It will be understood that other encoder and decoder block architecture can be used instead of that described above, including having varying layers from block to block and in one or more blocks rather than the same type of layers in multiple or all encoder and/or decoder blocks. Skip connections 350 and 352 between encoder and decoder blocks of the same level at the encoder 362 and 364 are shown and another one could be provided after first encoder block 318 and before last decoder block 336.

The decoder 364 generates two binaural audio signal output frames 336. Since the NN 300 can be operated during real time, the input and output frames should be kept at the same size (duration), and this true even though the number of channels (e.g., number of audio signals of different microphones) and number of frames at the input is different than the number of audio signals or frames at the output, which here is frames for two binaural audio signals. In the example here, the output frames will each be the 4.26 seconds for 204,800 samples at 48 kHz with a 50% hop, but otherwise may match the frames of the input to the time domain encoder. These frames can be provided for further audio processing.

With this NN 300 architecture, the NN 300 can be easily modified to receive input with any desired number of audio channels. Otherwise, by the example NN 300, the NN 300 does not have attention, fully connected, and recurrent layers in order to reduce the computational load to run the NN 300. Also, hyperparameters such as the number of encoding and/or decoding blocks, may be adjusted to work with relatively small frames for real-time processing. It will be appreciated, however, that the NN may have many different architecture variations.

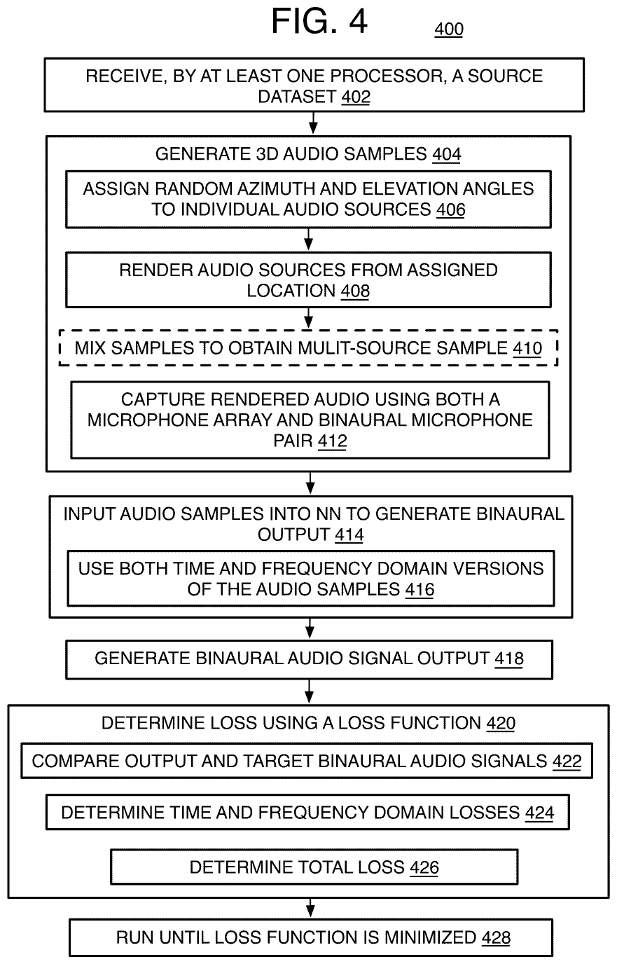

Referring to FIG. 4, an example process 400 for training a binaural audio emulation neural network is described. In the illustrated implementation, process 400 may include one or more operations, functions, or actions as illustrated by one or more of operations 402 to 428 generally numbered evenly. By way of non-limiting example, process 400 may be described herein with reference to example systems 100, 500, 1000, 1100 and 1200, and neural network 300 described herein with FIGS. 1, 3, 5 and 10-12, or any of the other systems, devices, processes, environments, or networks described herein, and where relevant.

Referring to FIG. 5, an audio processing system 500 may be used to operate the training method 400 and has a training system or unit 501 that can be used to train a binaural audio emulation neural network (NN) 520 similar to NN 300 and NN 118. The training system 501 may have at least one audio source 502, a head and torso (HAT) type of input device 504 with binaural audio microphones 508 and 510, and a microphone array 512, here with four microphones 514 and that is a linear array. As shown, both binaural audio signals 516 and non-binaural (or microphone array) audio signals 518 may be used to train the NN 520. The microphone array audio signals 518 are the input for the NN 520, while the binaural audio signals 516 are used as the supervised target output for the NN 520 to be compared to the actual output of the NN 520. The training unit 501 also may have a loss function unit 522, an optional white noise unit 524, and an optional an optional frequency weighting unit 526 for the reasons explained below with process 400.

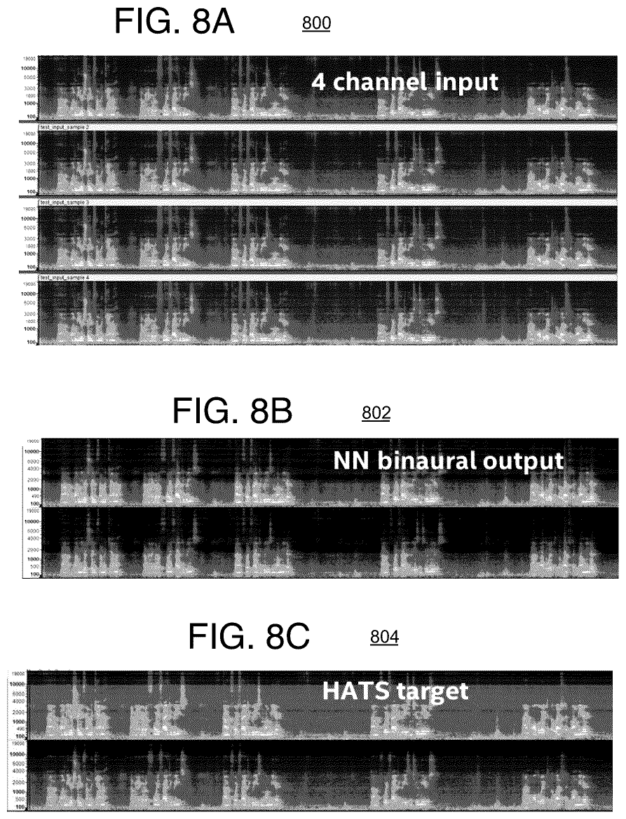

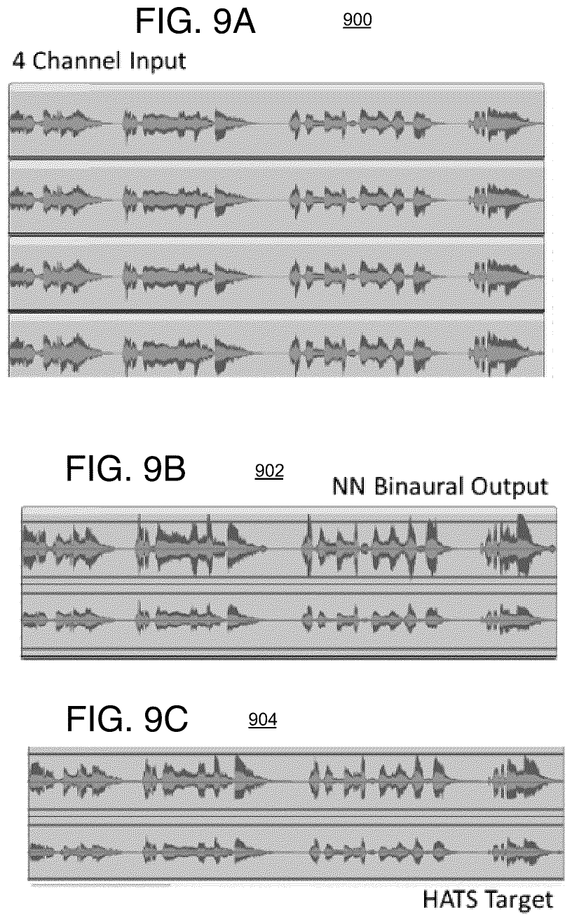

Returning to process 400, a deep learning NN, such as NN 300 (FIG. 3), 118 (FIG. 1), or 520 (FIG. 5) may be trained to perform audio source separation, which is another way of saying binaural audio emulation, and as described below. This process was used for training and testing with results provided below with FIGS. 8A-8C and 9A-9C.

Process 400 may include “receive, by at least one processor, a source dataset” 402. Here, one or more audio sources may be used where each audio source is to have a specific distance and angle relative to a position of an array of microphones in an anechoic chamber using a dedicated setup for training. The dataset may include a select number ‘A’ of mono audio signals and may be any desired types of audios such as from audio sources including one or more humans speaking (whether on a same audio source or separate audio sources), and any other sounds such as a vehicle horns, traffic, dog barking, musical instruments, baby crying, animal noises, and so forth. Such audio is often provided in audio datasets such as TIMIT.

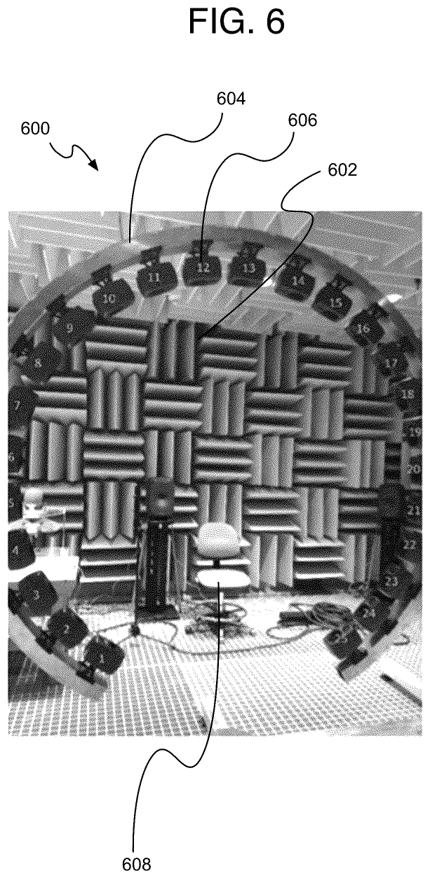

Referring to FIG. 6, process 400 may include “generate 3D audio samples” 404. This may include “assign random azimuth and elevation angles to individual audio sources” 406. Specifically, in an example training setup 600 used here, an anechoic chamber 602 has a speaker ring 604 that may be placed over or around an input device position 608. The speaker ring 604 may have a circular array of speakers 606, here being 25 speakers in a vertical arrangement although other number of speakers and orientations of the speaker ring may be used. Also while the input device position 608 merely shows a chair, the HATS device with the microphone array may be placed in this location instead, and may be moved to specific positions relative to the speaker ring 604. It should be noted that either the speaker ring 604 may be moved and/or rotated around the input device position 608, and/or the input device position 608 may be moved relative to the speaker ring 604.

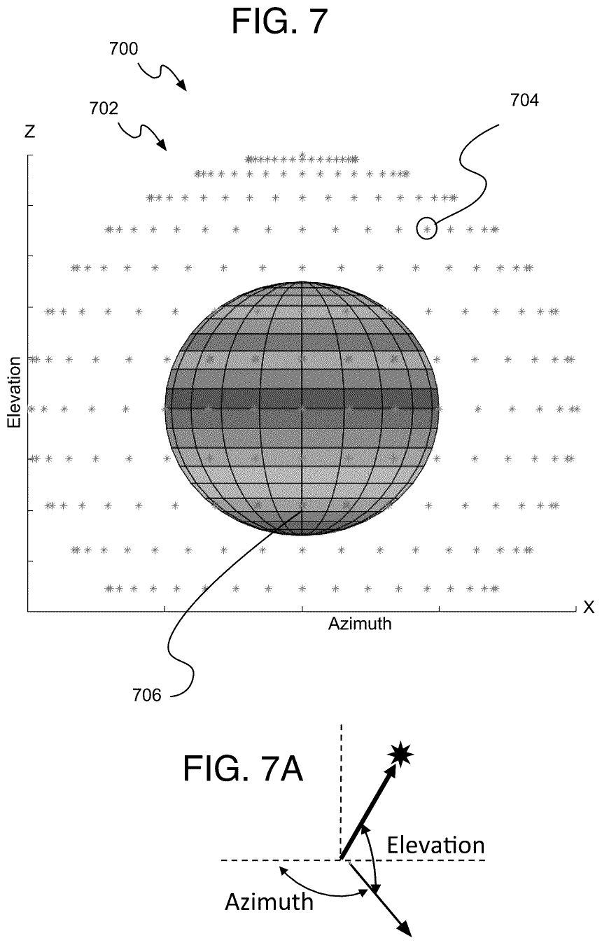

Referring to FIGS. 7 AND 7A, an example audio source map or graph 700 shows a point cloud 702 with audio source location points 704 that may be used and around a direction sphere 706 that represents a location of the audio input device, and that audio sources can be placed in any direction from the audio input device. The vertical axis Z of the graph 700 is the elevational direction and the horizontal axis X is the azimuth direction (the graph is in 2D and depth direction Y is not shown). FIG. 7A shows a key of the azimuth and elevational directions.

Process 400 may include “render audio sources from assigned location” 408. Each audio source was rendered from its assigned direction. By the example training and testing here, the ring of speakers was used to generate sources from 433 directions (25 different elevation angles and 18 azimuth angles).

Process 400 may include “mix samples to obtain multi-source sample” 410. Thus, by one example, cither multiple audio sources were used in a single emission time period or the individual samples were mixed together by channel-wise combination of their filtered signals. This was applied randomly in both direction and distance to replicate the real scenarios when multiple sounds are heard simultaneously, such as when a pet, refrigerator, and television are emitting audio to name one random example. By one example, three sources were mixed, but other numbers of audio sources may be used instead such as 1 to 4.

Process 400 may include “capture rendered audio using both a microphone array and binaural microphone pair” 412. Here, the HATS device and microphone array pick up the rendered audio. This operation also then may include using HRTF computations to generate the target or ground truth binaural audio signals from the HATS device. Impulse responses from the audio sources, here the 433 directions and varying angles around the HATS and microphone array device, were then captured (and measured) by generating frequencies of the audio signals that can be shown in spectrograms for example, as well as signal magnitudes.

Process 400 may include “input audio samples into NN to generate binaural output” 414, and “use both time and frequency domain versions of the audio samples” 416. As explained above, the 2D frequency surfaces and 1D time domain vectors are input into the NN, where the frequency domain surfaces each include multiple frequency bins of frequency values (or spectrums) for a single frame and the time domain vector includes a single frame of audio signal samples (or magnitudes or amplitudes). The 2D frequency surfaces and 1D vector are input into the respective frequency and time domain encoders. This may involve placing the surfaces into NN input buffers (or having the buffers accessible) that provide the input of the first layer of the NN. This also may involve placing the input values of the surfaces into MAC registers when accelerators are used.

Process 400 then may include “generate binaural audio signal output” 418, and in the form of frames with the same length as the input frames. Thus, the output is right and left binaural audio signal frames. By one example, the output frames may be of 4 to 4.5 second duration, and particularly 4.26 seconds in the example herein. The overlap (or hop) then may be removed to obtain a continuous signal when desired and as mentioned above for the run-time.

Process 400 may include “determine loss using a loss function” 420, and including “compare output and target binaural audio signals” 422. This may be performed separately for time and frequency domains so that determining the loss also includes “determine time and frequency domain losses” 424.

Specifically, two comparisons are performed. A first comparison is a direct comparison between the output (or estimated) and target (or expected) audio signal data. A second comparison is a comparison of differences between the right and left audio signals. In other words, the differences in left and right output audio signals may be compared to the differences in left and right target audio signals.

To determine a time domain loss, an L1 loss (mean absolute error (or MAE)) is computed between the output (or estimated) binaural signals and the expected (target), and computed between an L1 loss (MAE) between the output left-right differences and the target left-right differences, as follows in equation (1):

$${loss}_{time} = \vert {s}^{l . r} - {\hat{s}}^{l . r} \vert + \vert ( {s}^{l} - {s}^{r} ) - ( {\hat{s}}^{l} - {\hat{s}}^{r} ) \vert \qquad ( 1 )$$

where s=target (expected) signal, ŝ=neural network conversion (or in other words, the NN output (or estimated) binaural audio signals), 1=left audio signal from 1 to L, r=right audio signal from 1 to R, where R and L here are the samples at the same sample rate. The sample rate is the same for both the output and target audio signals, here being 48 kHz in this example. The equation then provides an average time domain lossₜᵢₘₑ for each frame output from the NN. It should be noted that other comparison computations may be used instead of MAE, and the direct and l−r difference comparisons may use different comparison computations.

Similarly to determine a frequency domain loss, an L1 loss (MAE) is computed between the output spectrograms of the output binaural audio signals and the target spectrograms of the target binaural audio signals, and computed between an L1 loss (MAE) between the output left-right differences and the target left-right differences, as follows in equation (2):

$${loss}_{frequency} = \vert {S}^{l . r} - {\hat{S}}^{l . r} \vert + \vert ( {S}^{l} - {S}^{r} ) - ( {\hat{S}}^{l} - {\hat{S}}^{r} ) \vert \qquad ( 2 )$$

where S=target (or expected) spectrogram, S=spectrogram from the neural network conversion (or in other words, the NN output binaural audio signals).

Process 400 may include “determine total loss” 426 where equations (1) and (2) are placed together in the total loss equations:

$$Total loss = {loss}_{time} + ( W ) {loss}_{frequency} \qquad ( 3 )$$

$$Total loss = \vert {s}^{l . r} - {\hat{s}}^{l . r} \vert + \vert ( {s}^{l} - {s}^{r} ) - ( {\hat{s}}^{l} - {\hat{s}}^{r} ) \vert + W ( \vert {S}^{l . r} - {\hat{S}}^{l . r} \vert + \vert ( {S}^{l} - {S}^{r} ) - ( {\hat{S}}^{l} - {\hat{S}}^{r} ) \vert ) \qquad ( 4 )$$

It should be noted that the loss function with both time and frequency-based components here can have a weighting factor (W) applied to either the frequency or time components to adjust their relative contributions, and such as a decimal value such as 0.4 determined by experimentation.

By one option, frequency weighting also may be applied while training the neural network. Specifically, a neural network may undesirably emphasize certain frequency responses on an entire spectrum of frequencies including low frequencies that are not within the human auditory range. It was found that for emulation that will mainly be used for human speech, better performance occurs when the neural network concentrates on the human hearing range. This can be accomplished by using a weighting function to multiply the spectrums by a frequency weight. This puts more emphasis on the frequencies that people hear and less on those that people do not hear, and specifically in the low frequencies such as 50 HZ, 20 Hz, or even 100 Hz. The weights can be applied during loss function computations when the target and output audio signals are being compared, which are vectors of losses or differences. Specifically, weights such as an A-weighting ponderation may be multiplied by each element in the vector. A-weighting is a continuous curve obtained from experimentation by capturing how well people hear at different frequencies, and the continuous curve may be transformed into a vector with as many bins (resolution) as desired.

Also, as another option related to frequency distribution, full or partial bands of white noise may be added to the microphone array audio signals 518 and the binaural audio signals 516 before the signals are used for the training. Specifically, and the for the training, the frequency distribution of the audio signals may be missing a sufficient amount of certain frequencies, and particularly high frequency signals even though a variety of audio sources are being used for the training. As a result, the neural network may not adequately learn to identify the position of sources with high frequency audio signals, which reduces the accuracy and clarity of the resulting audio. To solve this, one or more bands of broadband noise such as white noise (with high frequency components) may be added to both the microphone array audio signals (or samples) and the binaural audio signals (or samples) and added randomly in magnitude, time start, and duration to better balance the frequency distribution from the audio source dataset to be used. The white noise may be added by mixing a segment of noise to the original signals before being filtered, so that the noise is present on the input and output of the NN.

Process 400 may include “run NN until loss function is minimized” 428. Thus, the neural network may be run until the loss function achieves a stationary state (convergence or it has stopped decreasing in value, or a certain number of epochs have been reached. Once minimized, the hyper parameters (weights, bias, etc.) for the NN are set for sufficiently accurate binaural audio signal emulation.

To demonstrate the effectiveness of the binaural audio signal emulation NN, a training and testing system was set up as described above with process 400 using a four-mic array multi-camera and microphone device. As mentioned, the method is not limited to this specific array and can be used with many other multi-microphone arrays or patterns on many devices (or multiple devices) including on notebooks and other consumer devices.

The binaural signals were generated using HRTF as mentioned above, and four mono signals from a linear array of four microphones were generated using device related transfer functions (DRTFs) to model sound from specific directions.

A total of 13,028 audio segments of 5 second duration at 44.1 kHz of sampling frequency were collected. They were up sampled to 48 KHz to match with the sampling frequency of the microphone array being used (48 kHz). These audio signals were used to generate audio samples of multi-mono and binaural pairs, online with the neural network training. Multiple audio segments were selected randomly, and filtered for random directions, comprising a whole sphere around the head (as with FIG. 7).

Randomly, 80% of the segments were used for training and the rest (20%, 2,605 samples) were used for validation. The combination of different audios, distances, and directions significantly increases the chances of all samples being unique relative to each other.

Referring to FIGS. 8A-8C for the testing results, the spectrograms for the raw input signals (‘4 channel input’) 800 used in the training and testing of the binaural audio emulation neural network is shown along with the ground truth NN binaural output spectrograms 802 and the binaural HATS target network outputs 804. As shown by the strong similarity between the NN binaural output 802 from the neural network and the HATS target signals 804, the results demonstrate that the binaural audio emulation neural network is able to replicate the binaural spectrogram extremely well.

Referring to FIGS. 9A-9C, and here too, time domain audio signals of raw microphone array 4 channel input 900, neural network binaural output 902, and HATS ground truth target signals 904 are shown, where the NN binaural output 902 and HATS target signals 904 are very close. An analysis of both the time and frequency aspects of the signals shows that the neural network is able to adequately replicate the interaural time and level differences between the left and right (ear) signals providing realistic audio for human perception, localization, and immersion.

While implementation of the example processes 200 and 400 as well as systems or networks 100, 300, 500, 1000, 1100, and 1200 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality. Other than the term “logic unit”, the term “unit” refers to any one or combination of software logic, firmware logic, hardware logic, and/or circuitry configured to provide the functionality described herein.

As used in any implementation described herein, the term “component” may refer to a module, unit, or logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry.” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, and processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

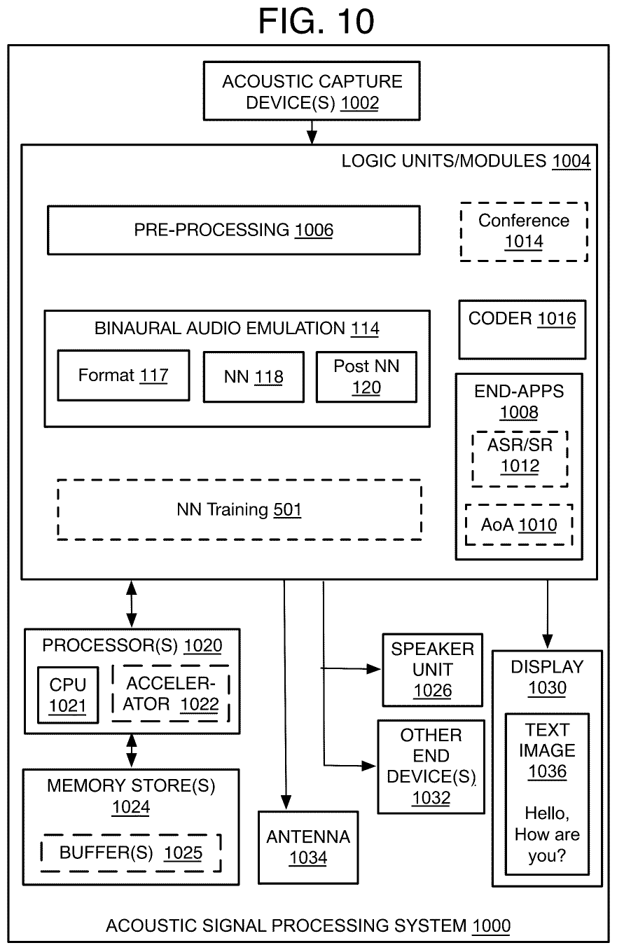

Referring to FIG. 10, an example acoustic signal processing system 1000 is arranged in accordance with at least some implementations of the present disclosure. In various implementations, the example acoustic signal processing system 1000 may have acoustic capture devices 1002, such as listening or input devices with microphones or microphone arrays as described herein. One or more microphones are present to receive acoustic waves and form acoustical signal data. This can be implemented in various ways. Thus, in one form, the acoustic signal processing system 1000 is one of the listening devices, or is on a device, with one or more microphones. In other examples, the acoustic signal processing system 1000 may be in communication with one or an array or network of listening devices 1002 with microphones, or in communication with at least two microphones. The system 1000 may be remote from these acoustic signal capture devices 1002 such that logic modules 1004 may communicate remotely with, or otherwise may be communicatively coupled to, the microphones for further processing of the acoustic data.

In either case, such technology may include a smart phone, smart speaker, a tablet, laptop or other computer, video or phone conference console, dictation machine, other sound recording machine, a mobile device or an on-board device, or any combination of these. Thus, in one form, audio capture devices 1002 may include audio capture hardware including one or more sensors (e.g., microphone or audio capture components) as well as actuator controls. These controls may be part of a sensor module or component for operating the sensor. The sensor component may be part of the audio capture device 1002, or may be part of the logical modules 1004 or both. Such sensor component can be used to convert sound waves into an electrical acoustic signal. The audio capture device 1002 also may have an A/D converter, AEC unit, other filters, and so forth to provide a digital signal for acoustic signal processing.

In the illustrated example, the logic units and modules 1004 may include a pre-processing unit 1006, a binaural audio emulation unit 114, and optionally a NN training unit 501 when device or system 1000 is also used for training. The binaural audio emulation unit 114 may have a format unit 117, a NN 118, and a post NN unit 120, as well as other units, and as already described above with FIG. 1.

For transmission and emission of the audio, the system 1000 may have a coder unit 1016 for encoding and an antenna 1034 for transmission to a remote output device, as well as a speaker 1026 for local emission. When the logic modules 1004 are on a host device for a phone conference for example, the logic modules 1004 also may include a conference unit 1014 to host and operate a video or phone conference system as mentioned herein.

The logic modules 1004 also may include an end-apps unit 1008 to perform further audio processing such as with an ASR/SR unit 1012, an AoA unit 1010, a beam-forming unit, and/or other end applications that may be provided to analyze and otherwise use the binaural audio emulated signals. The logic modules 1004 also may include other end devices 1032, which may include a decoder to decode input signals when audio is received via transmission, and if not already provided with coder unit 1016. These units may be used to perform the operations described above where relevant. The tasks performed by these units or components are indicated by their labels and may perform similar tasks as those units with similar labels as described above.

The acoustic signal processing system 1000 may have processor circuitry 1020 forming one or more processors which may include central processing unit (CPU) 1021 and/or one or more dedicated accelerators 1022 such as with the Intel Atom, memory stores 1024 with one or more buffers 1025 to hold audio-related data such as samples, frames, feature vectors, NN input data, intermediate NN data from any NN layer, NN output binaural audio signals, any NN training data, and so forth as described above, at least one speaker unit 1026 to emit audio based on the input audio signals, or responses thereto, when desired, one or more displays 1030 to provide images 1036 of text for example, as a visual response to the acoustic signals if such is used. The other end device(s) 1032 also may perform actions in response to the acoustic signal. In one example implementation, the acoustic signal processing system 1000 may have the at least one processor of the processor circuitry 1020 communicatively coupled to the acoustic capture device(s) 1002 (such as at least two microphones) and at least one memory 1024. As illustrated, any of these components may be capable of communication with one another and/or communication with portions of logic modules 1004 and/or audio capture device 1002. Thus, processors of processor circuitry 1020 may be communicatively coupled to the audio capture device 1002, the logic modules 1004, and the memory 1024 for operating those components.

While typically the label of the units or blocks on device 1000 at least indicates which functions are performed by that unit, a unit may perform additional functions or a mix of functions that are not all suggested by the unit label. Also, although acoustic signal processing system 1000, as shown in FIG. 10, may include one particular set of units or actions associated with particular components or modules, these units or actions may be associated with different components or modules than the particular component or module illustrated here,

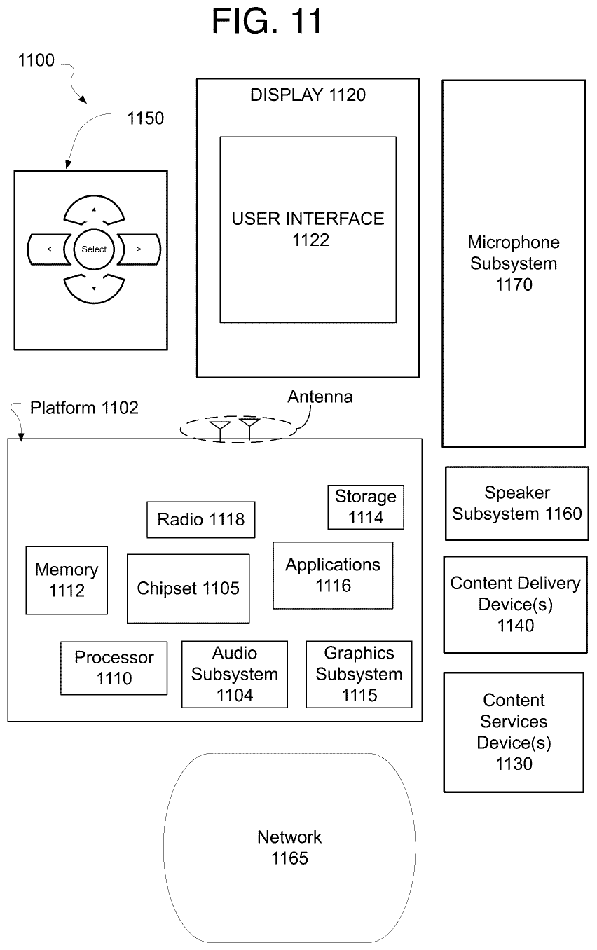

Referring to FIG. 11, an example system 1100 in accordance with the present disclosure operates one or more aspects of the speech processing system described herein. It will be understood from the nature of the system components described below that such components may be associated with, or used to operate, certain part or parts of the speech processing system described above. In various implementations, system 1100 may be a media system although system 1100 is not limited to this context. For example, system 1100 may be incorporated into multiple microphones of a network of microphones on listening devices, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any device that can provide one or more of the microphones, the audio signals from the microphones, the binaural audio emulation NN, and/or the training unit to train the binaural audio emulation NN.

In various implementations, system 1100 includes a platform 1102 coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102, speaker subsystem 1160, microphone subsystem 1170, and/or display 1120. Each of these components is described in greater detail below.

In various implementations, platform 1102 may include any combination of a chipset 1105, processor 1110, memory 1112 storage 1114, audio subsystem 1104, graphics subsystem 1115, applications 1116 and/or radio 1118. Chipset 1105 may provide intercommunication among processor 1110, memory 1112, storage 1114, audio subsystem 1104, graphics subsystem 1115, applications 1116 and/or radio 1118. For example, chipset 1105 may include a storage adapter (not depicted) capable of providing intercommunication with storage 1114. Either audio subsystem 1104 or the microphone subsystem 1170 may have any of the units related to binaural audio emulation described above.

Processor 1110 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1114 may include technology to increase the storage performance enhanced protection for valuable digital media when multiple hard drives are included, for example.

Audio subsystem 1104 may perform processing of audio such as acoustic signals for one or more audio-based applications such as binaural audio emulation as described herein, and/or other audio processing applications such as speech recognition, speaker recognition, and so forth. The audio subsystem 1104 may have audio conference (or the audio part of video conference) hosting modules. The audio subsystem 1104 may comprise one or more processing units, memories, and accelerators. Such an audio subsystem may be integrated into processor 1110 or chipset 1105. In some implementations, the audio subsystem 1104 may be a stand-alone card communicatively coupled to chipset 1105. An interface may be used to communicatively couple the audio subsystem 1104 to a speaker subsystem 1160, microphone subsystem 1170, and/or display 1120.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, Display Port, wireless HDMI, and/or wireless HD compliant techniques. Graphics subsystem 1115 may be integrated into processor 1110 or chipset 1105. In some implementations, graphics subsystem 1115 may be a stand-alone card communicatively coupled to chipset 1105.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further implementations, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120, speaker subsystem 1160, and microphone subsystem 1170. Platform 1102 and/or content services device(s) 1130 may be coupled to a network 1165 to communicate (e.g., send and/or receive) media information to and from network 1165. Content delivery device(s) 1140 also may be coupled to platform 1102, speaker subsystem 1160, microphone subsystem 1170, and/or to display 1120.

In various implementations, content services device(s) 1130 may include a network of microphones, a cable television box, personal computer, network, telephone, Internet enabled devices or appliance capable of delivering digital information and/or content, and any other similar device capable of unidirectionally or bidirectionally communicating content between content providers and platform 1102 and speaker subsystem 1160, microphone subsystem 1170, and/or display 1120, via network 1165 or directly. It will be appreciated that the content may be communicated unidirectionally and/or bidirectionally to and from any one of the components in system 1100 and a content provider via network 1165. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of controller 1150 may be used to interact with user interface 1122, for example. In implementations, navigation controller 1150 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1104 also may be used to control the motion of articles or selection of commands on the interface 1122.

Movements of the navigation features of controller 1150 may be replicated on a display (e.g., display 1120) by movements of a pointer, cursor, focus ring, or other visual indicators displayed on the display or by audio commands. For example, under the control of software applications 1116, the navigation features located on navigation controller 1150 may be mapped to virtual navigation features displayed on user interface 1122, for example. In implementations, controller 1150 may not be a separate component but may be integrated into platform 1102, speaker subsystem 1160, microphone subsystem 1170, and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example, or by auditory command. Program logic may allow platform 1102 to stream content to media adaptors or other content services device(s) 1130 or content delivery device(s) 1140 even when the platform is turned “off.” In addition, chipset 1105 may include hardware and/or software support for 8.1 surround sound audio and/or high definition (7.1) surround sound audio, for example. Drivers may include an auditory or graphics driver for integrated auditory or graphics platforms. In implementations, the auditory or graphics driver may comprise a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various implementations, platform 1102, audio subsystem 1104, speaker subsystem 1160, and/or microphone subsystem 1170 may be an integrated unit. Display 1120, speaker subsystem 1160, and/or microphone subsystem 1170 and content service device(s) 1130 may be integrated, or display 1120, speaker subsystem 1160, and/or microphone subsystem 1170 and content delivery device(s) 1140 may be integrated, for example. These examples are not meant to limit the present disclosure.

In various implementations, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, text message, any social website messaging, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 11.

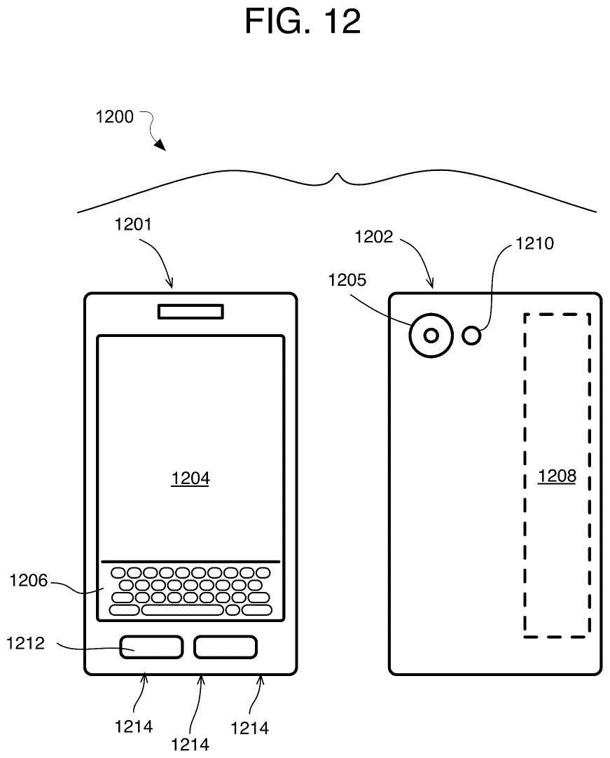

Referring to FIG. 12, a small form factor device 1200 is one example of the varying physical styles or form factors in which systems 1000 or 1100 may be embodied. By this approach, device 1200 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, smart speaker, or smart television), mobile internet device (MID), messaging device, data communication device, speaker system, microphone system or network, and so forth, and any other on-board (such as on a vehicle), or building, computer that may accept audio commands.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 12, device 1200 may include a housing with a front 1201 and a back 1202. Device 1200 includes a display 1204, an input/output (I/O) device 1206, and an integrated antenna 1208. Device 1200 also may include navigation features 1212. I/O device 1206 may include any suitable I/O device for entering information into a mobile computing device. Examples for I/O device 1206 may include an alphanumeric keyboard, a numeric keypad, a touch pad, input keys, buttons, switches, microphones, speakers, voice recognition device and software, and so forth. Information also may be entered into device 1200 by way of one or more microphones 1214 that may be part of a linear microphone array or other shape of microphone array. As shown, device 1200 may include a camera 1205 (e.g., including a lens, an aperture, and an imaging sensor) and a flash 1210 integrated into back 1202, front 1201, or elsewhere of device 1200.

Various implementations may be implemented using hardware elements, software elements, or a combination of both. Examples of hardware elements may include processor circuitry forming processors and/or microprocessors, as well as circuits, circuit elements (e.g., transistors, resistors, capacitors, inductors, and so forth), integrated circuits, application specific integrated circuits (ASIC), programmable logic devices (PLD), digital signal processors (DSP), fixed function hardware, field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.
In example 1, a computer-implemented method of audio processing comprises receiving, by processor circuitry, multiple audio signals from multiple microphones and overlapping in a same time and associated with a same at least one audio source; and generating binaural audio signals comprising inputting at least one version of the multiple audio signals into a neural network.
In example 2, the subject matter of example 1, wherein the multiple microphones provide sensitivity with a directional pattern.
In example 3, the subject matter of example 1 or 2, wherein the multiple microphones are in a linear array.
In example 4, the subject matter of example 1 or 2, wherein the multiple microphones are in a circular array.
In example 5, the subject matter of example 1 or 2, wherein the multiple microphones comprises a linear array of at least four microphones, and wherein the binaural audio signals are arranged to be used on headphones.
In example 6, the subject matter of any one of examples 1 to 5, wherein the multiple microphones are positioned in an array or pattern that corresponds in shape, number of microphones, or both to that of an array or pattern of a set of microphones used to train the neural network.
In example 7, the subject matter of any one of examples 1 to 6, wherein the multiple microphones comprise a number of microphones more than a number of microphones in a set of microphones used to train the neural network, and wherein the inputting comprises inputting multiple audio signals from an amount of microphones of the multiple microphones that is the same as the number of microphones in the set of microphones.
In example 8, the subject matter of any one of examples 1 to 7, wherein the inputting comprises inputting both time domain and frequency domain versions of the multiple audio signals into the neural network.
In example 9, the subject matter of any one of examples 1 to 8, wherein the neural network is trained by using at least two overlapping audio sources.
In example 10, at least one non-transitory computer readable medium comprising a plurality of instructions that in response to being executed on a computing device, causes the computing device to operate by: receiving multiple audio signals of a microphone array and of audio emitted from a same one or more sources at a same time; receiving target binaural audio signals of the audio; and training a neural network comprising inputting at least one version of the multiple audio signals into the neural network, outputting output binaural audio signals, and comparing the output binaural audio signals to the target binaural audio signals.
In example 11, the subject matter of example 10, wherein the training comprises using at least one audio source at a randomly selected angle and distance relative to a location of the microphone array.
In example 12, the subject matter of example 10 or 11, wherein the training comprises simultaneously using multiple audio sources positioned at randomly selected angles and distances different from audio source to audio source to generate overlapping audio sources.
In example 13, the subject matter of any one of examples 10 or 12, wherein the comparing comprises determining both a frequency domain loss and a time domain loss, and determining for both the frequency domain loss and the time domain loss both: a difference between output values of the output binaural audio signals and target values of the target binaural audio signals, and a difference between (1) differences between left and right values of the output binaural audio signals and (2) differences between left and right values of the target binaural audio signals.
In example 14, a computer-implemented system, comprising: memory to hold multiple audio signals from multiple microphones, wherein the multiple audio signals overlap in time and are associated with a same at least one audio source; and processor circuitry communicatively connected to the memory, the processor circuitry being arranged to operate by: generating binaural audio signals comprising inputting at least one version of the multiple audio signals into at least one neural network.
In example 15, the subject matter of example 14, wherein the binaural audio signals are associated with an interaural time difference and level difference set by the neural network.
In example 16, the subject matter of example 14 or 15, wherein the neural network comprises a time domain encoder, a frequency domain encoder, and a time domain decoder, wherein the frequency domain encoder feeds into a bottleneck between the time domain encoder and the time domain decoder.
In example 17, the subject matter of any one of examples 14 or 16, wherein the neural network comprises a time domain encoder providing time domain output, a frequency domain encoder providing frequency domain output, and a decoder, and wherein the processor circuitry operates by combining the frequency domain output and the time domain output to generate input of the decoder.
In example 18, the subject matter of any one of examples 14 to 17, wherein the neural network comprises a frequency domain encoder and a time domain encoder both having a sequence of repeating encoder blocks, wherein the encoder blocks individually comprise, in order, a first convolutional layer, a rectified linear unit layer, a second convolutional layer, and a gated linear unit layer.
In example 19, the subject matter of any one of examples 14 to 18, wherein the neural network comprises a time domain decoder having a sequence of repeating decoder blocks, wherein the decoder blocks individually comprise, in order, a convolutional layer, a gated linear unit layer, a transpose convolutional layer, and a rectified linear unit layer.
In example 20, and in addition to the subject matter of any one of examples 14 to 19, wherein the multiple microphones are in a same pattern shape as a pattern shape of an array of microphones used for training the neural network.
In example 21, a device or system includes a memory and processor circuitry to perform a method according to any one of the above examples.
In example 22, at least one machine readable medium includes a plurality of instructions that in response to being executed on a computing device, cause the computing device to perform a method according to any one of the above examples.
In example 23, an apparatus may include means for performing a method according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of audio processing, comprising:
receiving, by processor circuitry, multiple audio signals from multiple microphones and overlapping in a same time and associated with a same at least one audio source; and
generating binaural audio signals comprising inputting at least one version of the multiple audio signals into a neural network.

2. The method of claim 1, wherein the multiple microphones provide sensitivity with a directional pattern.

3. The method of claim 1, wherein the multiple microphones are in a linear array.

4. The method of claim 1, wherein the multiple microphones are in a circular array.

5. The method of claim 1, wherein the multiple microphones comprises a linear array of at least four microphones, and wherein the binaural audio signals are arranged to be used on headphones.

6. The method of claim 1, wherein the multiple microphones are positioned in an array or pattern that corresponds in shape, number of microphones, or both to that of an array or pattern of a set of microphones used to train the neural network.

7. The method of claim 1, wherein the multiple microphones comprise a number of microphones more than a number of microphones in a set of microphones used to train the neural network, and wherein the inputting comprises inputting multiple audio signals from a target number of microphones of the multiple microphones that is the same as the number of microphones in the set of microphones.

8. The method of claim 1, wherein the inputting comprises inputting both time domain and frequency domain versions of the multiple audio signals into the neural network.

9. The method of claim 1, wherein the neural network is trained by using at least two overlapping audio sources.

10. At least one non-transitory computer readable medium comprising a plurality of instructions that in response to being executed on a computing device, causes the computing device to operate by:
receiving multiple audio signals of a microphone array and of audio emitted from a same one or more sources at a same time;
receiving target binaural audio signals of the audio; and
training a neural network comprising inputting at least one version of the multiple audio signals into the neural network, outputting output binaural audio signals, and comparing the output binaural audio signals to the target binaural audio signals.

11. The medium of claim 10, wherein the training comprises using at least one audio source at a randomly selected angle and distance relative to a location of the microphone array.

12. The medium of claim 11, wherein the training comprises simultaneously using multiple audio sources positioned at randomly selected angles and distances different from audio source to audio source to generate overlapping audio sources.

13. The medium of claim 10, wherein the comparing comprises determining both a frequency domain loss and a time domain loss, and determining for both the frequency domain loss and the time domain loss both:
a difference between output values of the output binaural audio signals and target values of the target binaural audio signals, and
a difference between (1) differences between left and right values of the output binaural audio signals and (2) differences between left and right values of the target binaural audio signals.

14. A computer-implemented system, comprising:
memory to hold multiple audio signals from multiple microphones, wherein the multiple audio signals overlap in time and are associated with a same at least one audio source; and
processor circuitry communicatively connected to the memory, the processor circuitry being arranged to operate by:
generating binaural audio signals comprising inputting at least one version of the multiple audio signals into at least one neural network.

15. The system of claim 14, wherein the binaural audio signals are associated with an interaural time difference and level difference set by the neural network.

16. The system of claim 14, wherein the neural network comprises a time domain encoder, a frequency domain encoder, and a time domain decoder, wherein the frequency domain encoder feeds into a bottleneck between the time domain encoder and the time domain decoder.

17. The system of claim 14, wherein the neural network comprises a time domain encoder providing time domain output, a frequency domain encoder providing frequency domain output, and a decoder, and wherein the processor circuitry operates by combining the frequency domain output and the time domain output to generate input of the decoder.

18. The system of claim 14, wherein the neural network comprises a frequency domain encoder and a time domain encoder both having a sequence of repeating encoder blocks, wherein the encoder blocks individually comprise, in order, a first convolutional layer, a rectified linear unit layer, a second convolutional layer, and a gated linear unit layer.

19. The system of claim 14, wherein the neural network comprises a time domain decoder having a sequence of repeating decoder blocks, wherein the decoder blocks individually comprise, in order, a convolutional layer, a gated linear unit layer, a transpose convolutional layer, and a rectified linear unit layer.

20. The system of claim 14, wherein the multiple microphones are in a same pattern shape as a pattern shape of an array of microphones used for training the neural network.
